(19) United States
(12) Patent Application Publication
(10) Pub. No.: US 2026/0181091 A1
(43) Pub. Date: Jun. 25, 2026

(54) MEDIUM CONVEYANCE DEVICE AND IMAGE READING DEVICE

(71) Applicant: SEIKO EPSON CORPORATION, Tokyo (JP)

(72) Inventor: Satoshi NAKATA, MATSUMOTO-SHI (JP)

(21) Appl. No.: 19/426,235

(22) Filed: Dec. 19, 2025

(30) Foreign Application Priority Data
Dec. 23, 2024 (JP) 2024-226102

(51) Int. Cl. H04N 1/00

(52) U.S. Cl. CPC H04N 1/00909; H04N 1/00615; H04N 1/00732; H04N 2201/0081

(57) ABSTRACT

A medium conveyance device includes a guide part that guides a medium being conveyed, a detector that is disposed to face the guide part, and a flow path forming portion that forms a flow space in which a gas can flow between the guide part and the flow path forming portion. The flow space is a space in which the gas taken in from a ventilation portion reaches an exhaust portion via the detector, and a flow velocity of the gas at the detector in the flow space is equal to or larger than a flow velocity of the gas at the ventilation portion.

The present application is based on, and claims priority from JP Application Serial Number 2024-226102, filed December 23, 2024, the disclosure of which is hereby incorporated by reference herein in its entirety.

### BACKGROUND

### 1. Technical Field

The present disclosure relates to a medium conveyance device that conveys a medium, and an image reading device equipped with the medium conveyance device.

### 2. Related Art

A paper conveyance apparatus disclosed in JP-A-2014-60494 includes a housing, a guide part attached to the housing and configured to guide paper conveyed through a paper conveyance path, and a sound collector provided in a space between the housing and the guide part. The paper conveyance apparatus further includes a ventilation path that communicates the inside and the outside of the space between the housing and the guide part in order to send an air flow to the sound collector to clean the sound collector.

JP-A-2014-60494 is an example of the related art.

The ventilation path disclosed in JP-A-2014-60494 is not devised from the viewpoint of increasing a flow velocity of a gas near the sound collector, and has a structure in which the flow velocity of the gas near the sound collector may be slower than a flow velocity of the gas at a ventilation port, and there is room for improvement from the viewpoint of appropriately cleaning the sound collector.

### SUMMARY

In order to solve the above problem, a medium conveyance device according to the present disclosure includes: a guide part configured to guide a medium being conveyed; a detector disposed to face the guide part; and a flow path forming portion configured to form a flow space in which a gas is allowed to flow between the guide part and the flow path forming portion, in which the flow space is a space in which the gas taken in from a ventilation portion reaches an exhaust portion via the detector, and a flow velocity of the gas at the detector in the flow space is equal to or larger than a flow velocity of the gas at the ventilation portion.

An image reading device according to the present disclosure includes: the medium conveyance device; and a reading unit configured to read a medium conveyed by the medium conveyance device.

### BRIEF DESCRIPTION OF THE DRAWINGS

FIG. 1 is a view showing a medium conveyance path in an image reading device.

FIG. 2 is an appearance perspective view showing the image reading device with an opening and closing unit omitted.

FIG. 3 is an enlarged perspective view showing the periphery of a separation roller shown in FIG. 2.

FIG. 4 is a view showing a state in which a cover member and the separation roller are removed from a state shown in FIG. 3.

FIG. 5 is a view showing a state in which a guide part is removed from the state shown in FIG. 4.

FIG. 6 is a cross-sectional view showing the guide part, a base member, and a microphone taken along a position of an introduction port.

FIG. 7 is a cross-sectional view showing the guide part, the base member, and the microphone taken along the position of the introduction port.

### DESCRIPTION OF EMBODIMENTS

The present disclosure will schematically be described below.

A medium conveyance device according to a first aspect includes: a guide part configured to guide a medium being conveyed; a detector disposed to face the guide part; and a flow path forming portion configured to form a flow space in which a gas is allowed to flow between the guide part and the flow path forming portion, in which the flow space is a space in which the gas taken in from a ventilation portion reaches an exhaust portion via the detector, and a flow velocity of the gas at the detector in the flow space is equal to or larger than a flow velocity of the gas at the ventilation portion.

In the case of a theoretical value at least when a pressure loss is ignored, the flow velocity of the gas at the detector may be equal to or larger than the flow velocity of the gas at the ventilation portion.

According to the present aspect, since the flow velocity of the gas at the detector in the flow space is equal to or larger than the flow velocity of the gas at the ventilation portion, a reduction in the flow velocity of the gas at the detector is prevented, and the detector can be effectively cleaned.

In a second aspect according to the first aspect, a cross-sectional area of the flow space at the detector is equal to or smaller than a cross-sectional area of the flow space at the ventilation portion.

According to the present aspect, since the cross-sectional area of the flow space at the detector is equal to or smaller than the cross-sectional area of the flow space at the ventilation portion, the flow velocity of the gas at the detector can be made equal to or larger than the flow velocity of the gas at the ventilation portion, and the detector can be effectively cleaned.

In a third aspect according to the second aspect, the cross-sectional area of the flow space at the detector is smaller than the cross-sectional area of the flow space at the ventilation portion.

According to the present aspect, since the cross-sectional area of the flow space at the detector is smaller than the cross-sectional area of the flow space at the ventilation portion, the flow velocity of the gas at the detector can be made larger than the flow velocity of the gas at the ventilation portion, and the detector can be effectively cleaned.

In a fourth aspect according to the third aspect, a cross-sectional area of the flow space at a first position between the detector and the ventilation portion is larger than the cross-sectional area of the flow space at the detector and smaller than a cross-sectional area of the flow space at a second position between the ventilation portion and the first position, and the cross-sectional area of the flow space at the second position is smaller than the cross-sectional area of the flow space at the ventilation portion.

According to the present aspect, since the cross-sectional area is reduced from the ventilation portion toward the detector, the flow velocity of the gas at the detector can be efficiently increased, and the detector can be effectively cleaned.

In a fifth aspect according to the first aspect, the flow path forming portion includes a first portion located upstream of the detector in a flow direction of the gas, and a second portion located downstream of the first portion and upstream of the detector in the flow direction, and the first portion and the second portion are coupled to each other to guide the gas to a downstream side in the flow direction.

According to the present aspect, since the first portion and the second portion are coupled to each other to guide the gas to the downstream side in the flow direction, the fluidity of the gas from the ventilation portion toward the detector is ensured, the flow velocity of the gas at the detector can be ensured, and a reduction in the flow velocity of the gas at the detector can be prevented. That is, the flow velocity of the gas at the detector can be made equal to or larger than the flow velocity of the gas at the ventilation portion, and the detector can be effectively cleaned.

Note that the present aspect is not necessarily an aspect according to the first aspect described above, and may be an aspect according to any one of the second to fourth aspects described above.

In a sixth aspect according to the first aspect, an upstream end of the flow path forming portion in a flow direction of the gas faces the ventilation portion, the gas flowing in from the ventilation portion is divided into a gas toward the flow space and a gas toward a space different from the flow space from the upstream end of the flow path forming portion, and a flow velocity of the gas from the upstream end of the flow path forming portion toward the flow space is larger than a flow velocity of the gas from the upstream end of the flow path forming portion toward the space different from the flow space.

According to the present aspect, since a flow velocity of the gas toward the detector is increased by branching the gas in two directions at the upstream end of the flow path forming portion, the detector can be effectively cleaned.

Note that the present aspect is not necessarily an aspect according to the first aspect described above, and may be an aspect according to any one of the second to fifth aspects described above.

In a seventh aspect according to the sixth aspect, the flow path forming portion has a blade cross-sectional shape.

According to the present aspect, since the flow path forming portion has a blade cross-sectional shape, it is possible to easily obtain a configuration in which the flow velocity of the gas toward the detector is increased by branching the gas in the two directions at the upstream end of the flow path forming portion.

In an eighth aspect according to the seventh aspect, the upstream end of the flow path forming portion is curved to protrude toward an upstream side in the flow direction.

According to the present aspect, in a configuration in which the upstream end of the flow path forming portion is curved to protrude toward the upstream side in the flow direction, the effect according to the sixth or seventh aspect described above can be obtained.

Note that the present aspect is not necessarily an aspect according to the seventh aspect described above, and may be an aspect according to the sixth aspect described above.

In a ninth aspect according to the eighth aspect, a downstream end of the flow path forming portion in the flow direction has a shape tapered toward the downstream side in the flow direction.

According to the present aspect, since the downstream end of the flow path forming portion in the flow direction has a shape tapered toward the downstream side in the flow direction, the flow velocity of the gas toward the detector can be effectively increased, and the detector can be effectively cleaned.

In a tenth aspect according to the seventh aspect, the flow path forming portion includes an upstream part located upstream of the detector in the flow direction, and a downstream part located downstream of the detector in the flow direction, an upstream end of the upstream part in the flow direction is curved to protrude toward the upstream side in the flow direction, and a downstream end of the downstream part in the flow direction has a shape tapered toward the downstream side in the flow direction.

According to the present aspect, since the downstream end of the downstream part in the flow direction has a shape tapered toward the downstream side in the flow direction, the flow velocity of the gas toward the detector can be effectively increased, and the detector can be effectively cleaned.

Further, since the path forming portion is implemented by a plurality of members including the upstream part and the downstream part, it is possible to easily form each member while preventing an increase in size of each member.

The present aspect is not necessarily an aspect according to the seventh aspect described above, and may be an aspect according to any one of the sixth, the eighth, and the ninth aspects described above.

In an eleventh aspect according to any one of the first to tenth aspects, the ventilation portion is provided upstream of the detector in a conveyance direction of the medium.

According to the present aspect, since the ventilation portion is provided upstream of the detector in the conveyance direction of the medium, the gas flows in from the ventilation portion due to an air flow caused by the conveyance of the medium, and thus the detector can be effectively cleaned.

In a twelfth aspect according to any one of the first to tenth aspects, the exhaust portion is provided downstream of the detector in a conveyance direction of the medium.

According to the present aspect, since the exhaust portion is provided downstream of the detector in the conveyance direction of the medium, the detector can be effectively cleaned when a flow of the gas occurs in the flow space due to an air flow caused by the conveyance of the medium.

Note that the present aspect is not necessarily an aspect according to any one of the first to tenth aspects described above, and may be an aspect according to the eleventh aspect.

In a thirteenth aspect according to any one of the first to tenth aspects, the exhaust portion is provided outward of a width of the medium in a width direction intersecting a conveyance direction of the medium.

According to the present aspect, in a configuration in which the exhaust portion is provided outward of the width of the medium in the width direction intersecting the conveyance direction of the medium, the effect according to any one of the first to tenth aspects described above can be obtained.

Note that the present aspect is not necessarily an aspect according to any one of the first to tenth aspects described above, and may be an aspect according to any one of the eleventh and the twelfth aspects.

In a fourteenth aspect according to any one of the first to tenth aspects, an opening is formed in the flow path forming portion, and an accommodation portion that accommodates a foreign substance is further provided below the opening.

According to the present aspect, since the accommodation portion that accommodates the foreign substance is further provided below the opening, it is possible to prevent the foreign substance removed from the detector from scattering into the device and adversely affecting the device.

Note that the present aspect is not necessarily an aspect according to any one of the first to tenth aspects described above, and may be an aspect according to any one of the eleventh to thirteenth aspects.

In a fifteenth aspect according to any one of the first to tenth aspects, an airflow generator configured to send the gas to the ventilation portion is further provided.

According to the present aspect, since the airflow generator that sends the gas to the ventilation portion is further provided, the detector can be effectively cleaned.

Note that the present aspect is not necessarily an aspect according to any one of the first to tenth aspects described above, and may be an aspect according to any one of the eleventh to fourteenth aspects.

In a sixteenth aspect according to any one of the first to tenth aspects, the detector is a sensor configured to detect the medium being conveyed.

According to the present aspect, in a configuration in which the detector is a sensor configured to detect the medium being conveyed, it is possible to prevent deterioration of detection accuracy of the medium.

Note that the present aspect is not necessarily an aspect according to any one of the first to tenth aspects described above, and may be an aspect according to any one of the eleventh to fifteenth aspects.

In a seventeenth aspect according to any one of the first to tenth aspects, the detector includes a microphone that collects sound generated in a medium conveyance path.

According to the present aspect, in a configuration in which the detector includes the microphone that collects the sound generated in the medium conveyance path, it is possible to prevent deterioration in sound collection accuracy.

Note that the present aspect is not necessarily an aspect according to any one of the first to tenth aspects described above, and may be an aspect according to any one of the eleventh to fifteenth aspects.

In an eighteenth aspect according to the seventeenth aspect, the guide part is formed with an introduction port for guiding the sound generated in the medium conveyance path to the detector, and the introduction port is located downstream of the detector in a conveyance direction of the medium.

According to the present aspect, since the introduction port is located downstream of the detector in the conveyance direction of the medium, it is possible to prevent a foreign substance entering from the introduction port from adhering to the detector.

In a nineteenth aspect according to the eighteenth aspect, the exhaust portion is located downstream of the introduction port in the conveyance direction.

According to the present aspect, since the exhaust portion is located downstream of the introduction port in the conveyance direction, a foreign substance adhered to the introduction port can be discharged from the exhaust portion.

An image reading device according to a twentieth aspect includes the medium conveyance device according to any one of the first to tenth aspects, and a reading unit configured to read a medium conveyed by the medium conveyance device.

According to the present aspect, in the image reading device, the effects according to the first to tenth aspects described above can be obtained.

The medium conveyance device in the present aspect may be the medium conveyance device according to any one of the eleventh to nineteenth aspects.

The present disclosure will be specifically be described below.

A X-Y-Z coordinate system shown in the drawings is an orthogonal coordinate system in which a direction pointed by an arrow is a +X direction and a direction opposite to the +X direction is a -X direction. An X-axis direction is a direction intersecting a conveyance direction of a medium, that is, a medium width direction, and is a device width direction.

A Y-axis direction is a device depth direction. In the Y-axis direction, a +Y direction is a direction from a device back surface toward a device front surface, and a -Y direction is a direction from the device front surface toward the device back surface.

A Z-axis direction is a vertical direction and is a device height direction. In the Z-axis direction, a +Z direction is an upward direction, and a -Z direction is a downward direction.

An image reading device 1 in the present embodiment is a scanner capable of reading an image on a medium, and is a sheet-feed type scanner that reads an image on a medium while conveying the medium. Here, the image on the medium refers to an image visually recorded on the medium, and is, for example, a character, a figure, a table, a picture, and a photograph. The medium is not limited to a sheet, and includes a card, a booklet, and the like.

The image reading device 1 can also be referred to as a medium conveyance device 2 from the viewpoint of conveying a medium. In this case, the image reading device 1 includes the medium conveyance device 2, and a first reading unit 25 and a second reading unit 26 to be described later.

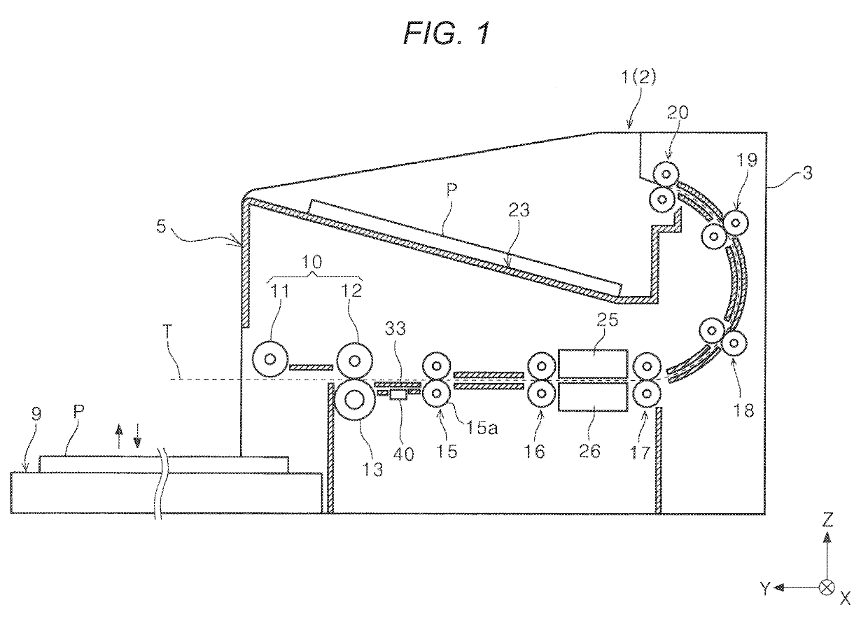

As shown in FIG. 1, the image reading device 1 includes a conveyance path T for conveying a medium. The conveyance path T is formed inside a device main body 3. In FIG. 1, the conveyance path T is indicated by a broken line. In the conveyance path T, a medium P is linearly conveyed along the -Y direction, then inverted upward, and discharged in the +Y direction.

Hereinafter, a configuration of the conveyance path T will be described along a direction in which a medium is conveyed. Hereinafter, the direction in which the medium is conveyed may be referred to as "downstream" and a direction opposite to a downstream side may be referred as "upstream".

A medium support portion 9 that supports the medium is provided on a most upstream side of the conveyance path T. The medium support portion 9 horizontally supports the medium. Of course, the medium support portion 9 may support the medium in an inclined posture. A reference numeral P denotes a medium supported by the medium support portion 9. Hereinafter, a medium is referred to as the medium P with the reference numeral P.

The medium support portion 9 is lifted and lowered along the vertical direction while maintaining a posture by a power source (not shown). When the medium support portion 9 is lifted, the medium P supported by the medium support portion 9 can come into contact with a pick roller 11.

The pick roller 11 is driven by a motor (not shown) and feeds the medium P supported by the medium support portion 9 to the downstream side.

A feed roller 12 is provided downstream of the pick roller 11 in the conveyance path T. The feed roller 12 is driven by a motor (not shown) and feeds the medium P to the downstream side.

The pick roller 11 and the feed roller 12 constitute a feed unit 10 that feeds the medium P from the medium support portion 9.

A separation roller 13 is provided at a position facing the feed roller 12. The separation roller 13 separates the medium P by nipping the medium P with the feed roller 12. The separation roller 13 is driven by a motor (not shown) in a direction in which the medium P is returned to the upstream side. A torque limiter (not shown) is interposed in a power transmission path between the separation roller 13 and the motor (not shown). When there is only one medium P between the feed roller 12 and the separation roller 13, the separation roller 13 is driven to rotate to come into contact with the medium P by the action of the torque limiter. When there are a plurality of media P between the feed roller 12 and the separation roller 13, the separation roller 13 rotates in the direction in which the medium P is returned to the upstream side by power of the motor (not shown), and thus multi-feed is prevented.

Instead of the separation roller 13, a separation pad may be employed.

The pick roller 11, the feed roller 12, and the separation roller 13 described above are provided at a center position in the medium width direction or positions symmetrical with respect to the center position.

Next, downstream of the feed roller 12 in the conveyance path T, a first conveyance roller pair 15, a second conveyance roller pair 16, and a third conveyance roller pair 17 are provided in this order toward the downstream side. In the conveyance path T, a section from the pick roller 11 to the third conveyance roller pair 17 extends horizontally.

At least one roller of the first conveyance roller pair 15, the second conveyance roller pair 16, and the third conveyance roller pair 17 is driven by a motor (not shown). The first conveyance roller pair 15, the second conveyance roller pair 16, and the third conveyance roller pair 17 convey the medium P to the downstream side.

A reference numeral 15a denotes a conveyance roller provided on a lower side in the first conveyance roller pair 15. A detector 40 is provided between the separation roller 13 and the conveyance roller 15a. In the present embodiment, the detector 40 includes a microphone that collects sound generated in the conveyance path T. A reference numeral 33 denotes a guide part that guides the medium P between the separation roller 13 and the conveyance roller 15a. The detector 40 is disposed below the guide part 33 and faces the guide part 33.

The first reading unit 25 is provided above the conveyance path T between the second conveyance roller pair 16 and the third conveyance roller pair 17. The second reading unit 26 is provided below the conveyance path T between the second conveyance roller pair 16 and the third conveyance roller pair 17. The first reading unit 25 and the second reading unit 26 are provided between the second conveyance roller pair 16 and the third conveyance roller pair 17 in a manner of facing each other with the conveyance path T interposed therebetween. Of course, the first reading unit 25 and the second reading unit 26 may be provided at the positions shifted in the conveyance direction.

The first reading unit 25 reads an image on a first surface of the medium P. The second reading unit 26 reads an image on a second surface opposite to the first surface of the medium P.

The first reading unit 25 and the second reading unit 26 each include, for example, a contact image sensor (CIS).

The conveyance path T is curved upward and inverted downstream of the third conveyance roller pair 17. In the curved and reversed section, a fourth conveyance roller pair 18, a fifth conveyance roller pair 19, and a sixth conveyance roller pair 20 are provided in this order toward the downstream side. At least one roller of the fourth conveyance roller pair 18, the fifth conveyance roller pair 19, and the sixth conveyance roller pair 20 is driven by a motor (not shown). The fourth conveyance roller pair 18 and the fifth conveyance roller pair 19 convey the medium P to the downstream side. The sixth conveyance roller pair 20 discharges the medium P in the +Y direction.

The medium P discharged by the sixth conveyance roller pair 20 is supported by a discharge receiving portion 23. The discharge receiving portion 23 supports the medium P in the inclined posture. Of course, the discharge receiving portion 23 may support the medium P in a horizontal posture.

A series of operations such as a lifting and lowering operation of the medium support portion 9, a rotation operation of each roller, and reading of an image on the medium P by the first reading unit 25 and the second reading unit 26 is controlled by a control unit (not shown). The control unit includes a CPU, a nonvolatile memory, and the like (not shown). Programs, parameters, and the like for performing various kinds of control are stored in the nonvolatile memory.

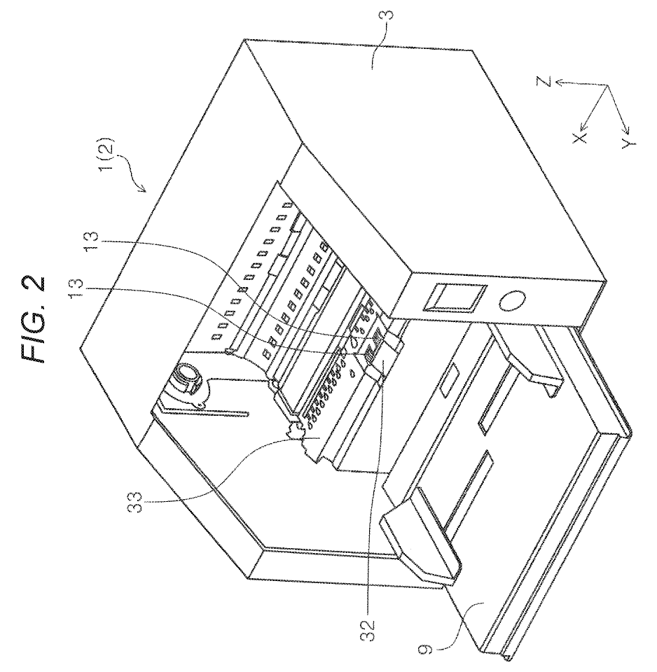

Next, an opening and closing unit 5 is provided in the device main body 3 in a manner of being openable and closable. The opening and closing unit 5 forms a part of the conveyance path T in a close state. The opening and closing unit 5 opens a part of the conveyance path T as shown in FIG. 2 in a state in which the opening and closing unit 5 is opened with respect to the device main body 3. In FIG. 2, the opening and closing unit 5 in an open state is not shown. The opening and closing unit 5 may be detachably provided at the device main body 3.

In particular, the opening and closing unit 5 is provided with the discharge receiving portion 23, the pick roller 11, and the feed roller 12. When the opening and closing unit 5 is opened, the feed roller 12 is separated from the separation roller 13, and the separation roller 13 is exposed as shown in FIG. 2.

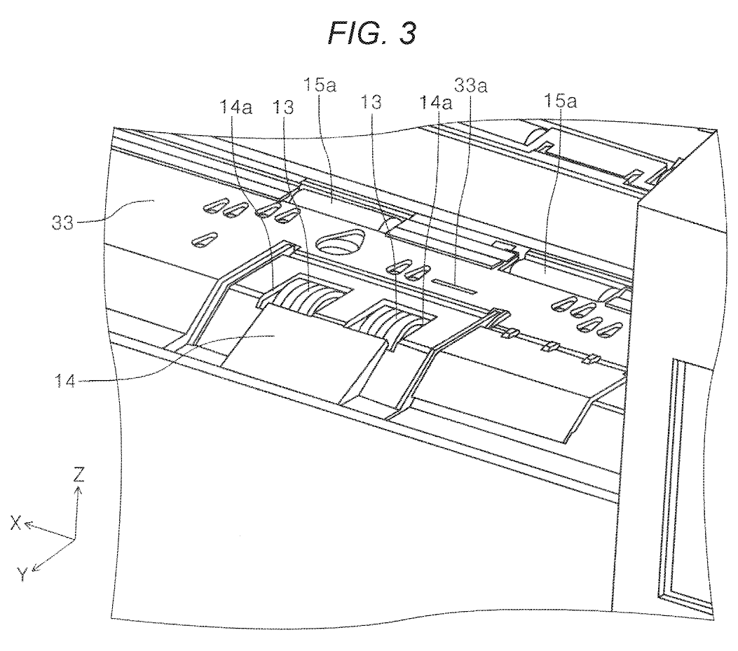

FIG. 3 is an enlarged view showing the periphery of the separation roller 13 in FIG. 2. The separation roller 13 is exposed through an opening 14a provided in a cover member 14. The cover member 14 is provided to be openable and closable with respect to the guide part 33. An introduction port 33a is provided at the downstream side in the conveyance direction with respect to the separation roller 13 in the -X direction of the two separation rollers 13 provided in the width direction. The introduction port 33a will be described later again.

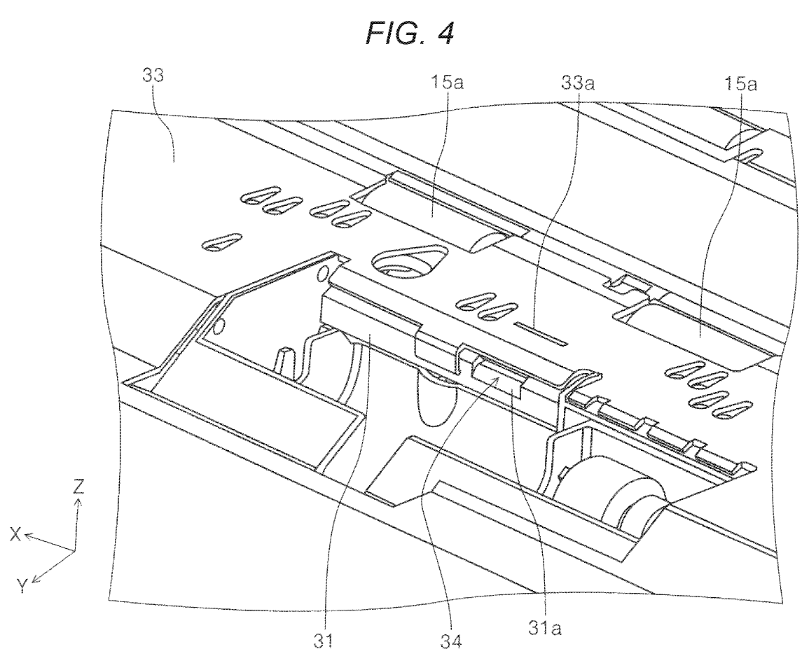

FIG. 4 is a view showing a state in which the cover member 14 is removed from the state shown in FIG. 3 and further the separation roller 13 is removed. In FIG. 4, a reference numeral 34 denotes a ventilation portion.

The ventilation portion 34 is a portion that takes in a gas, and is formed between the guide part 33 and a base member 31. A reference numeral 31a denotes an upstream forming portion formed in the base member 31.

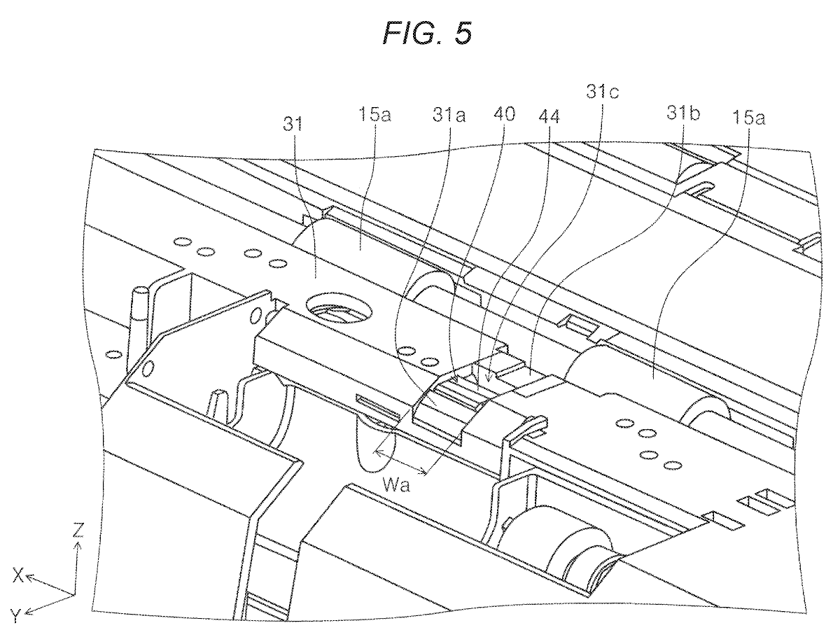

FIG. 5 is a view showing a state in which the guide part 33 is further removed from the state shown in FIG. 4 and the base member 31 is exposed. The upstream forming portion 31a is formed to be recessed from an upper surface of the base member 31, and a reference numeral Wa denotes a size of the upstream forming portion 31a in the width direction. Further, downstream of the upstream forming portion 31a in the conveyance direction, the detector 40, an opening 31c and a downstream forming portion 31b are provided in this order along the conveyance direction. The detector 40 is fixed to the base member 31.

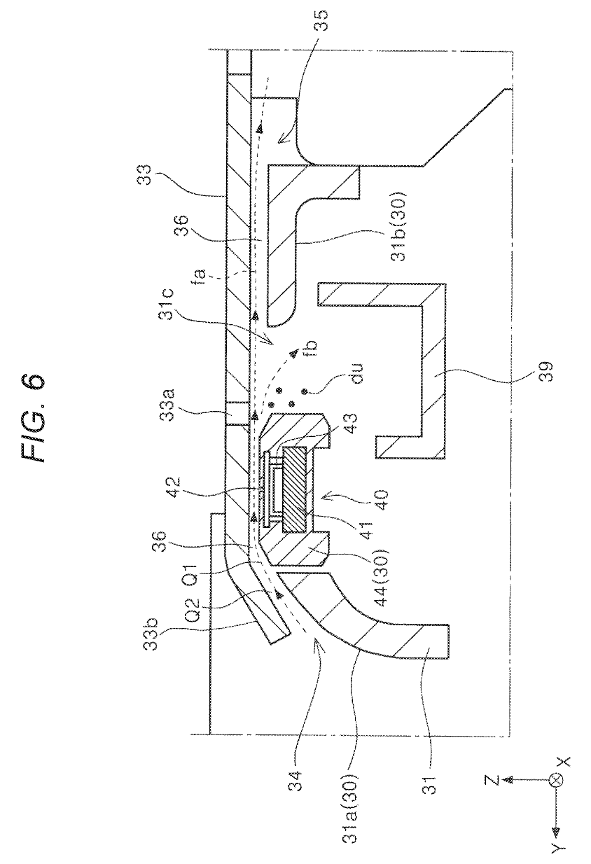

As shown in FIG. 6, a flow space 36 is formed between the guide part 33 and the base member 31. The detector 40 which is a microphone includes a substrate 41, a microphone element 43, and an exterior member 44. The microphone element 43 converts sound collected at a position of a sound collector 42 into an electric signal. The sound collector 42 is a hole. The control unit (not shown) of the image reading device 1 can detect that a jam occurred in the conveyance path T based on a signal received from the detector 40. The sound generated in the conveyance path T reaches the sound collector 42 from the introduction port 33a formed in the guide part 33.

The exterior member 44 forming an outer shell of the detector 40 can be formed of an elastic material such as silicon rubber.

A dustproof member such as woven fabric or non-woven fabric may be provided between the sound collector 42 and the microphone element 43.

Next, an upstream end 33b of the guide part 33 in the conveyance direction is inclined downward toward the upstream side in the conveyance direction, and the ventilation portion 34 is formed between the upstream end 33b and the upstream forming portion 31a. An arrow indicated by a broken line indicates a flow direction of a gas taken into the flow space 36 from the ventilation portion 34. The gas taken into the flow space 36 from the ventilation portion 34 passes above the detector 40 and further flows in the -Y direction. When the gas taken into the flow space 36 from the ventilation portion 34 passes above the detector 40, a foreign substance du adhered onto an upper surface of the detector 40 is removed.

Since the opening 31c is formed between the detector 40 and the downstream forming portion 31b, an air flow fa along a lower surface of the guide part 33 and an air flow fb directed downward are generated at the downstream side of the detector 40 in the flow direction. The foreign substance du blown by an air flow between the detector 40 and the guide part 33 easily falls down and is caused to be accommodated in an accommodation portion 39 by the airflow fb. The accommodation portion 39 is a tray-shaped portion located below the opening 31c. The accommodation portion 39 may be detachably provided. By providing the accommodation portion 39, it is possible to prevent a foreign substance removed from the detector 40 from scattering into the device and adversely affecting the device.

An outlet of the flow space 36 formed between the downstream forming portion 31b and the guide part 33 serves as an exhaust portion 35. In the present embodiment, the exhaust portion 35 faces an arrangement space of the conveyance roller 15a. Although the exhaust portion 35 does not communicate with the outside of the device in the present embodiment as described above, the exhaust portion 35 may communicate with the outside of the device.

In the present embodiment, the upstream forming portion 31a, the exterior member 44 constituting the detector 40, and the downstream forming portion 31b constitute a flow path forming portion 30 that forms the flow space 36 in which a gas can flow between the flow path forming portion 30 and the guide part 33.

In the present embodiment, the flow space 36 becomes narrower from the ventilation portion 34 toward the detector 40. In the present embodiment, the size Wa (see FIG. 5) of the flow space 36 in the width direction is constant at least from the ventilation portion 34 toward the detector 40. On the other hand, a gap between the guide part 33 and the flow path forming portion 30 is reduced toward the downstream side in the flow direction as shown in FIG. 6. That is, a cross-sectional area of the flow space 36 at the detector 40 is equal to or smaller than a cross-sectional area of the flow space 36 at the ventilation portion 34.

Accordingly, a flow velocity of the gas at the detector 40 in the flow space 36 is equal to or higher than a flow velocity of the gas at the ventilation portion 34. As a result, a reduction in the flow velocity of the gas at the detector 40 is prevented, and the detector 40 can be effectively cleaned. Even when the flow velocity of the gas at the detector 40 in the flow space 36 is equal to the flow velocity of the gas at the ventilation portion 34, the detector 40 can be effectively cleaned as compared with a configuration in which the flow velocity of the gas at the detector 40 in the flow space 36 is lower than the flow velocity of the gas at the ventilation portion 34.

The inflow of the gas from the ventilation portion 34 into the flow space 36 may be performed by a user injecting air using an air duster or the like, or may be performed by providing a fan (not shown) below the ventilation portion 34 and generating an air flow by the fan. Such a fan is an example of an airflow generator that sends a gas to the ventilation portion 34.

In the present embodiment, the cross-sectional area of the flow space 36 at the detector 40 is equal to or smaller than the cross-sectional area of the flow space 36 at the ventilation portion 34. More specifically, the cross-sectional area of the flow space 36 at the detector 40 is smaller than the cross-sectional area of the flow space 36 at the ventilation portion 34.

Accordingly, the flow velocity of the gas at the detector 40 can be made equal to or larger than the flow velocity of the gas at the ventilation portion 34, and the detector 40 can be effectively cleaned.

In the present embodiment, the size Wa (see FIG. 5) of the flow space 36 in the width direction is constant, and the gap between the guide part 33 and the flow path forming portion 30 is reduced toward the downstream side in the flow direction, thereby forming the above-described relationship of the cross-sectional area. However, in addition to or instead of reducing the gap between the guide part 33 and the flow path forming portion 30 toward the downstream side in the flow direction, the size Wa of the flow space 36 in the width direction may be reduced toward the downstream side in the flow direction.

In the present embodiment, a cross-sectional area of the flow space 36 at a first position Q1 between the detector 40 and the ventilation portion 34 is larger than the cross-sectional area of the flow space 36 at the detector 40 and smaller than a cross-sectional area of the flow space 36 at a second position Q2 between the ventilation portion 34 and the first position Q1. The cross-sectional area of the flow space 36 at the second position Q2 is smaller than the cross-sectional area of the flow space 36 at the ventilation portion 34.

In such a cross-sectional area relationship, that is, in a configuration in which the cross-sectional area of the flow space 36 is reduced from the ventilation portion 34 toward the detector 40, the flow velocity of the gas at the detector 40 can be efficiently increased, and the detector 40 can be effectively cleaned.

However, even if the cross-sectional area of the flow space 36 temporarily increases from the ventilation portion 34 toward the detector 40, the flow velocity of the gas at the detector 40 may be equal to or larger than the flow velocity of the gas at the ventilation portion 34.

The flow path forming portion 30 includes the upstream forming portion 31a which is a first portion located upstream of the detector 40 in the flow direction of the gas, and the exterior member 44 which is a second portion located downstream of the upstream forming portion 31a in the flow direction of the gas. The upstream forming portion 31a and the exterior member 44 are coupled to each other to guide the gas to the downstream side in the flow direction.

In other words, an upper surface of the upstream forming portion 31a and an upper surface of the exterior member 44 are flush with each other without a step in the coupled portion. Accordingly, fluidity of the gas from the ventilation portion 34 toward the detector 40 is ensured, the flow velocity of the gas at the detector 40 can be ensured, and the detector 40 can be effectively cleaned.

The upper surface of the upstream forming portion 31a and the upper surface of the exterior member 44 are not necessarily flush with each other, and may have a step of a certain level. In this case, in the coupled portion, the upper surface of the exterior member 44 may be higher or lower than the upper surface of the upstream forming portion 31a.

Although it is preferable that there is no gap between the upstream forming portion 31a and the exterior member 44, there may be a certain degree of gap between the upstream forming portion 31a and the exterior member 44.

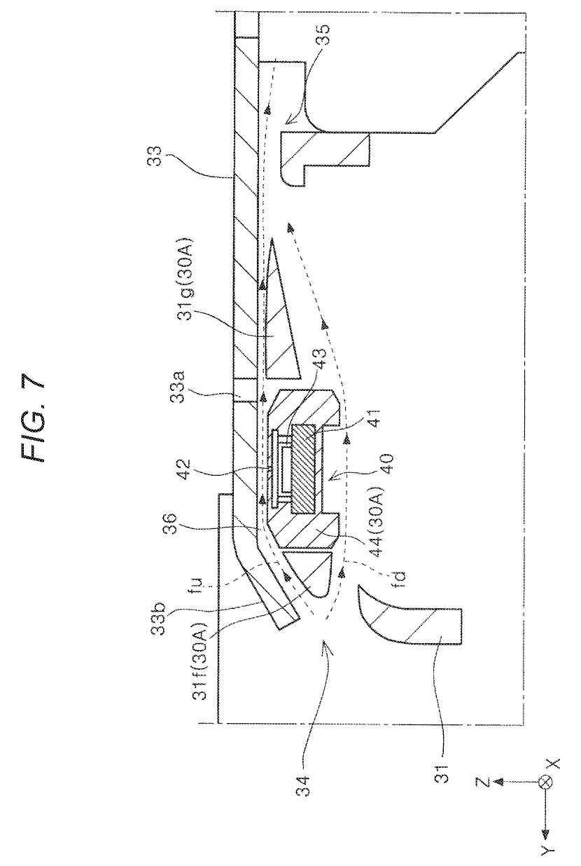

Next, another embodiment of the flow path forming portion will be described with reference to FIG. 7. In the following description, the same components as those already described are denoted by the same reference numerals, and redundant description will be omitted.

A flow path forming portion 30A shown in FIG. 7 includes an upstream forming portion 31f provided in the base member 31, the exterior member 44 constituting the detector 40, and a downstream forming portion 31g provided in the base member 31. The upstream forming portion 31f is an example of an upstream part located upstream of the detector 40, and the downstream forming portion 31g is an example of a downstream part located downstream of the detector 40.

An upstream end of the flow path forming portion 30A in the flow direction of the gas faces the ventilation portion 34. The gas flowing in from the ventilation portion 34 is divided into a gas flowing from the upstream end of the flow path forming portion 30A toward the flow space 36 and a gas flowing toward a space different from the flow space 36. A reference numeral fu denotes a flow direction of the gas from the upstream end of the flow path forming portion 30A toward the flow space 36. A reference numeral fd denotes a flow direction of the gas from the upstream end of the flow path forming portion 30A toward the space different from the flow space 36. In the present embodiment, the space different from the flow space 36 is a space below the flow path forming portion 30A.

In the present embodiment, the flow path forming portion 30A has a blade cross-sectional shape. Accordingly, the gas flowing in the flow direction fu has a larger flow velocity than the gas flowing in the flow direction fd. As a result, the detector 40 can be effectively cleaned.

In the present embodiment, since the flow path forming portion 30A has a blade cross-sectional shape, it is possible to easily obtain a configuration in which the gas is branched in two directions at the upstream end of the flow path forming portion 30A to increase the flow velocity of the gas toward the detector 40.

However, the flow path forming portion 30A is not limited to have the blade cross-sectional shape, and may have any shape as long as a so-called lift force is generated. That is, the gas may be branched in two directions at the upstream end of the flow path forming portion 30A to increase the flow velocity of the gas toward the detector 40.

The upstream end of the flow path forming portion 30A, specifically, an upstream end of the upstream forming portion 31f is curved to protrude toward the upstream side in the flow direction.

A downstream end of the flow path forming portion 30A in the flow direction, specifically, a downstream end of the downstream forming portion 31g has a shape tapered toward the downstream side in the flow direction.

Accordingly, the flow velocity of the gas toward the detector 40 can be effectively increased, and the detector 40 can be effectively cleaned.

The flow path forming portion 30A includes the upstream forming portion 31f located upstream of the detector 40 in the flow direction of the gas and the downstream forming portion 31g located downstream of the detector 40 in the flow direction of the gas. Since the flow path forming portion 30A is implemented by a plurality of members in this manner, it is possible to easily form each member while preventing an increase in size of each member.

However, the blade cross-sectional shape may be formed of a plurality of members as in the present embodiment, or may be formed of a single member.

The accommodation portion 39 described with reference to FIG. 6 may be provided below the flow path forming portion 30A, particularly, below the downstream end of the downstream forming portion 31g.

Next, a configuration, an operation, and an effect common to embodiments of FIGS. 6 and 7 will be described below.

First, the ventilation portion 34 is provided upstream of the detector 40 in the conveyance direction of the medium P. Accordingly, since the gas flows from the ventilation portion 34 due to an air flow caused by the conveyance of the medium P, the detector 40 can be effectively cleaned.

In the above embodiments, the foreign substance du removed from the detector 40 by the gas sent from the ventilation portion 34 flows to the downstream side of the detector 40. Here, the foreign substance du in the flow space 36 is also caused to flow by the air flow caused by the conveyance of the medium P in the conveyance path T as described above. Therefore, even when the foreign substance du removed from the detector 40 is caused to flow due to the air flow generated in the conveyance path T, the foreign substance du is less likely to adhere again to the detector 40 located upstream of the removed foreign substance du in the conveyance direction.

Next, the exhaust portion 35 is provided downstream of the detector 40 in the conveyance direction of the medium P. Accordingly, when a gas flow occurs in the flow space 36 due to the air flow caused by the conveyance of the medium P, the detector 40 can be effectively cleaned.

The introduction port 33a for guiding the sound generated in the conveyance path T to the sound collector 42 is formed in the guide part 33. The introduction port 33a is located downstream of the detector 40 in the conveyance direction of the medium P. Accordingly, it is possible to prevent a foreign substance entering from the introduction port 33a from adhering to the detector 40. When a position of the introduction port 33a is shifted from a position of the detector 40, the foreign substance entering from the introduction port 33a is less likely to reach the detector 40. Even when air is injected from the introduction port 33a to the inside, it is possible to prevent the detector 40 from being damaged by the air injection.

Even when the introduction port 33a is located at the position of the detector 40 in the conveyance direction of the medium P, the above-described effects can be obtained as long as the introduction port 33a is shifted in the width direction.

The introduction port 33a may also serve as the exhaust portion 35.

The introduction port 33a may be provided outward of a width of the medium P in the width direction intersecting the conveyance direction of the medium P.

The exhaust portion 35 is located downstream of the introduction port 33a in the conveyance direction. Accordingly, a foreign substance adhered to the introduction port 33a can be discharged from the exhaust portion 35.

Since the exhaust portion 35 is provided downstream of the sound collector 42 and the introduction port 33a in the conveyance direction, a foreign substance entering from the exhaust portion 35 is less likely to adhere to the sound collector 42 and the introduction port 33a.

Next, modifications of the above embodiments will be described.

First, the exhaust portion 35 may be provided outward of the width of the medium P in the width direction intersecting the conveyance direction of the medium P. For example, when the exhaust portion 35 is formed in the guide part 33 in a similar manner to the introduction port 33a, the medium P can be prevented from being caught by the exhaust portion 35 by providing the exhaust portion 35 outward of the width of the medium P in the width direction.

In the present embodiment, the ventilation portion 34, the detector 40, the introduction port 33a, and the exhaust portion 35 have substantially the same position in the width direction, and are arranged substantially linearly along the conveyance direction. Accordingly, a gas fed from the ventilation portion 34 blows off a foreign substance near the detector 40, and the flow of the gas discharged from the exhaust portion 35 becomes smooth.

In the present embodiment, the detector 40 is implemented by a microphone that collects sound generated in the conveyance path T, and prevents deterioration of sound collection accuracy by blowing a foreign substance adhered to the detector 40 by the above-described airflow, but the detector 40 is not limited thereto. For example, the detector 40 may be a sensor capable of detecting the medium P being conveyed. In this case, it is possible to prevent deterioration of detection accuracy of the medium P by blowing the foreign substance adhered to the detector 40 by the air flow described above. Examples of such a sensor include an optical sensor and an ultrasonic sensor.

The above-described configuration in which the detector 40 is cleaned by the flow path forming portion 30, 30A is applied to the image reading device in the above-described embodiment, but may be applied to a recording device that performs recording on a medium.

The present disclosure is not limited to the embodiments and modifications described above and various modifications can be made within the scope of the disclosure set forth in the appended claims, and it is needless to say that these modifications also fall within the scope of the present disclosure.

What is claimed is:

1. A medium conveyance device comprising:
a guide part configured to guide a medium being conveyed;
a detector disposed to face the guide part; and
a flow path forming portion configured to form a flow space in which a gas is allowed to flow between the guide part and the flow path forming portion, wherein
the flow space is a space in which the gas taken in from a ventilation portion reaches an exhaust portion via the detector, and
a flow velocity of the gas at the detector in the flow space is equal to or larger than a flow velocity of the gas at the ventilation portion.

2. The medium conveyance device according to claim 1, wherein
a cross-sectional area of the flow space at the detector is equal to or smaller than a cross-sectional area of the flow space at the ventilation portion.

3. The medium conveyance device according to claim 2, wherein
the cross-sectional area of the flow space at the detector is smaller than the cross-sectional area of the flow space at the ventilation portion.

4. The medium conveyance device according to claim 3, wherein
a cross-sectional area of the flow space at a first position between the detector and the ventilation portion is larger than the cross-sectional area of the flow space at the detector and smaller than a cross-sectional area of the flow space at a second position between the ventilation portion and the first position, and
the cross-sectional area of the flow space at the second position is smaller than the cross-sectional area of the flow space at the ventilation portion.

5. The medium conveyance device according to claim 1, wherein
the flow path forming portion includes
a first portion located upstream of the detector in a flow direction of the gas, and
a second portion located downstream of the first portion and upstream of the detector in the flow direction, and
the first portion and the second portion are coupled to each other to guide the gas to downstream in the flow direction.

6. The medium conveyance device according to claim 1, wherein
an upstream end of the flow path forming portion in a flow direction of the gas faces the ventilation portion,
the gas flowing in from the ventilation portion is divided into a gas toward the flow space and a gas toward a space different from the flow space from the upstream end of the flow path forming portion, and
a flow velocity of the gas from the upstream end of the flow path forming portion toward the flow space is larger than a flow velocity of the gas from the upstream end of the flow path forming portion toward the space different from the flow space.

7. The medium conveyance device according to claim 6, wherein
the flow path forming portion has a blade cross-sectional shape.

8. The medium conveyance device according to claim 7, wherein
the upstream end of the flow path forming portion is curved to protrude toward an upstream side in the flow direction.

9. The medium conveyance device according to claim 8, wherein
a downstream end of the flow path forming portion in the flow direction has a shape tapered toward a downstream side in the flow direction.

10. The medium conveyance device according to claim 7, wherein
the flow path forming portion includes
an upstream part located upstream of the detector in the flow direction, and
a downstream part located downstream of the detector in the flow direction,
an upstream end of the upstream part in the flow direction is curved to protrude toward an upstream side in the flow direction, and
a downstream end of the downstream part in the flow direction has a shape tapered toward a downstream side in the flow direction.

11. The medium conveyance device according to claim 1, wherein
the ventilation portion is provided upstream of the detector in a conveyance direction of the medium.

12. The medium conveyance device according to claim 1, wherein
the exhaust portion is provided downstream of the detector in a conveyance direction of the medium.

13. The medium conveyance device according to claim 1, wherein
the exhaust portion is provided outward of a width of the medium in a width direction intersecting a conveyance direction of the medium.

14. The medium conveyance device according to claim 1, wherein
an opening is formed in the flow path forming portion, and
an accommodation portion that accommodates a foreign substance is provided below the opening.

15. The medium conveyance device according to claim 1, further comprising:
an airflow generator configured to send the gas to the ventilation portion.

16. The medium conveyance device according to claim 1, wherein
the detector is a sensor configured to detect the medium being conveyed.

17. The medium conveyance device according to claim 1, wherein
the detector includes a microphone that collects sound generated in a medium conveyance path.

18. The medium conveyance device according to claim 17, wherein
the guide part is formed with an introduction port for guiding the sound generated in the medium conveyance path to the detector, and
the introduction port is located downstream of the detector in a conveyance direction of the medium.

19. The medium conveyance device according to claim 18, wherein
the exhaust portion is located downstream of the introduction port in the conveyance direction.

20. An image reading device comprising:
the medium conveyance device according to claim 1; and
a reading unit configured to read a medium conveyed by the medium conveyance device.
